(19) United States
(12) Patent Application Publication
(10) Pub. No.: US 2008/0120250 A1
(43) Pub. Date: May 22, 2008

(54) Method and system for generating and trading derivative investment instruments based on an implied correlation index

(75) Inventor: John C. Hiatt, Jr., Woodridge, IL (US)

Correspondence Address: BRINKS HOFER GILSON & LIONE, P.O. BOX 10395, CHICAGO, IL, 60610, US

(73) Assignee: Chicago Board Options Exchange, Incorporated

(21) Appl. No.: 11/602,913

(22) Filed: Nov. 20, 2006

(51) Int. Cl. G06F 17/00; G06F 15/16; G06Q 40/00

(52) U.S. Cl. 705/36 R; 709/202

(57) ABSTRACT

A system and method for creating and trading derivative instruments based on an implied correlation index is disclosed. A version of the method may include obtaining implied volatility values for both a stock index and constituent stocks in the stock index. A value reflecting an implied correlation between the stock index and constituents of the index is calculated and one or more values reflecting the implied correlation are displayed at a trading facility. A system for carrying out the method may include an implied index correlation module configured to generate an implied correlation value, and a dissemination module in communication with a communications network that is configured to transmit the implied correlation value to a market participant.

### TECHNICAL FIELD

The present invention relates generally to financial trading systems and more particularly to the generation, identification, processing, trading, quotation, and valuation of implied correlation indices and related derivative investment instruments.

### BACKGROUND

An index is a statistical composite that is used to indicate the performance of a market or a market sector over various time periods. Examples of indices that are used to gauge the performance of stocks and other securities in the United States include the Dow Jones® Industrial Average, the National Association of Securities Dealers Automated Quotations (NASDAQ®) Composite Index, the New York Stock Exchange® Composite Index, etc. In general, the Dow Jones® Industrial Average contains thirty (30) stocks that trade on the New York Stock Exchange® and is a general indicator of how shares of the largest United States companies are trading. The NASDAQ® Composite Index is a composite index of more than three thousand (3,000) companies listed on the NASDAQ® (also referred to as over-the-counter or OTC stocks). It is designed to indicate the stock performance of small-cap and technology stocks. Finally, the New York Stock Exchange® Composite Index is a composite index of shares listed on the New York Stock Exchange®.

In equal-dollar weighted indices, the weights of each component are reset to equal values at regular intervals, such as for example, every quarter. Between re-adjustments, the weights of the various index components will deviate from the equal-dollar weighting values as the values of the components fluctuate. Periodically, indices must be adjusted in order to reflect changes in the component companies comprising the index, or to maintain the original intent of the index in view of changing conditions in the market. For example, if a component stock's weight drops below an arbitrary threshold, or if a component company significantly alters its line of business or is taken over by another company so that it no longer represents the type of company which the index is intended to track, the index may no longer be influenced by, or reflect the aspects of the market for which it was originally designed. In such cases it may be necessary to replace a component stock with a suitable replacement stock. If a suitable replacement that preserves the basic character of the index cannot be found, the stock may simply be dropped without adding a replacement. Conversely, activity in the market for which an index is created may dictate that a new stock (which was not originally included in the index) having a strong impact in the market be added to the index to adequately reflect the market without eliminating other components. In each case, the divisor may be adjusted so that the index remains at the same level immediately after the new stock is added or the old stock is eliminated.

Derivatives are financial securities whose values are derived in part from a value or characteristic of some other underlying asset or variable (the underlying asset). The underlying asset may include securities such as stocks, market indicators and indices, interest rate, and corporate debt, such as bonds, to name but a few. Two common forms of derivatives are options contracts and futures contracts, discussed herein below.

An option is a contract giving the holder of the option the right, but not the obligation, to buy or sell an underlying asset at a specific price on or before a certain date. Generally, a party who purchases an option is said to have taken a long position with respect to the option. The party who sells the option is said to have taken a short position. There are generally two types of options: calls and puts. An investor who has taken a long position in a call option has bought the right to purchase the underlying asset at a specific price, known as the “strike price.” If the long investor chooses to exercise the call option, the long investor pays the strike price to the short investor, and the short investor is obligated to deliver the underlying asset.

Alternatively, an investor who has taken a long position in a put option receives the right, but not the obligation to sell the underlying asset at a specified price, again referred to as the strike price on or before a specified date. If the long investor chooses to exercise the put option, the short investor is obligated to purchase the underlying asset from the long investor at the agreed upon strike price. The long investor must then deliver the underlying asset to the short investor. Thus, the traditional settlement process for option contracts involves the transfer of funds from the purchaser of the underlying asset to the seller, and the transfer of the underlying asset from the seller of the underlying asset to the purchaser. Cash settlement, however, is more common. Cash settlement allows options contracts to be settled without actually transferring the underlying asset.

A call option is “in-the-money” when the price or value of the underlying asset rises above the strike price of the option. A put option is “in-the-money” when the price or value of the underlying asset falls below the strike price of the option. An at-the-money option wherein the price or value of the underlying asset is equal to the strike price of the option. A call option is out-of-the-money when the price or value of the underlying asset is below the strike price. A put option is out-of-the-money when the price or value of the underlying asset is above the strike price. If an option expires at-the-money or out-of-the-money, it has no value. The short investor retains the amount paid by the long investor (the option price) and pays nothing to the long investor. Cash settlement of an in-the-money option, be it a call or a put, however, requires the short investor to pay to the long investor the difference between the strike price and the current market value of the underlying asset.

Cash settlement allows options to be based on more abstract underlying “assets” such as market indicators, stock indices, interest rates, futures contracts and other derivatives. For example, an investor may take a long position in a market index call option. In this case, the long investor receives the right to “purchase” not the index itself, but rather a cash amount equal to the value of the index (typically multiplied by a multiplier) at a specified strike value. An index call option is in-the-money when the value of the index rises above the strike value. When the holder of an in-the-money index call option exercises the option, the short investor on the opposite side of the contract is obligated to pay the long investor the difference between the current value of the index and the strike price, usually multiplied by the multiplier. If the current value of the index is less than or equal to the strike value, the option has no value. An index put option works in the same way but in reverse, having value, or being in-the-money when the value of the index falls below the strike value.

Futures contracts are another common derivative security. In a futures contract a buyer purchases the right to receive delivery of an underlying commodity or asset on a specified date in the future. Conversely, a seller agrees to deliver the commodity or asset to an agreed location on the specified date. Futures contracts originally developed in the trade of agricultural commodities, but quickly spread to other commodities as well. Because futures contracts establish a price for the underlying commodity in advance of the date on which the commodity must be delivered, subsequent changes in the price of the underlying asset will inure to the benefit of one party and to the detriment of the other. If the price rises above the futures price, the seller is obligated to deliver the commodity at the lower agreed upon price. The buyer may then resell the received product at the higher market price to realize a profit. The seller in effect loses the difference between the futures contract price and the market price on the date the goods are delivered. Conversely if the price of the underlying commodity falls below the futures price, the seller can obtain the commodity at the lower market price for delivery to the buyer while retaining the higher futures price. In this case the seller realizes a profit in the amount of the difference between the current market price on the delivery date and the futures contract price. The buyer sees an equivalent loss.

Like options contracts, futures contracts may be settled in cash. Rather than actually delivering the underlying asset, cash settlement merely requires payment of the difference between the market price of the underlying commodity or asset on the delivery date and the futures contract price. The difference between the market price and the futures price is to be paid by the short investor to the long investor, or by the long investor to the short investor, depending on which direction the market price has moved. If the prevailing market price is higher than the contract price, the short investor must pay the difference to the long investor. If the market price has fallen, the long investor must pay the difference to the short investor.

Again, like options, cash settlement allows futures contracts to be written against more abstract underlying “assets” or “commodities,” such as market indicators, stock indices, interest rates, futures contracts and other derivatives. For example, an investor may take a long position in a market index futures contract. In this case, the long investor “buys” the index at a specified futures price (i.e. a future value of the index on the “delivery” date). The index based futures contract is cash settled. One party to the contract pays the difference between the futures price and the actual value of the index (often multiplied by a specified multiplier) to the other investor depending on which direction the market has moved. If the value of the index has moved above the futures price, or futures value, the short investor pays the difference the long investor. If the value of the index has moved below the futures price, or futures value the long investor pays the difference to the short investor.

Cash settlement provides great flexibility regarding the types of underlying assets that derivative investment instruments may be built around. Essentially any variable whose value is subject to change over time, may serve as the underlying asset for a derivative investment instrument. While standard derivatives may be based on many different underlying assets, no index or derivative investment instruments based thereon exist that capture changes in the performance of an implied correlation index or the performance of volatility dispersion (correlation) trading strategies.

### BRIEF SUMMARY

In order to address the need for improvements on derivative investment instruments, implied correlation index derivative investment instruments and methods for creating an implied correlation index are disclosed herein that are based on changes in the correlation between the implied volatility of a index option, such as the Dow Jones Index (DJX) options, and the implied volatilities of options on the constituent stocks that comprise the index.

According to a first aspect of the disclosure, a computer-readable medium containing processor executable program instructions for creating an implied correlation index is disclosed including obtaining implied volatility values for a stock index and a plurality of constituents of the stock index, calculating a value reflecting an implied correlation between the stock index and the plurality of constituents of the stock index; and wherein a value reflecting an implied correlation is calculated according to the formula:

$$corr = ( {σ}_{p}^{2} - {\sum }_{i = 1}^{N} {w}_{i}^{2} {σ}_{i}^{2} ) / 2 {\sum }_{i = 1}^{N} {\sum }_{j > i} {w}_{i} {w}_{j} {σ}_{i} {σ}_{j}$$

where, σₚ≡an implied volatility of the stock index, σᵢ,σⱼ≡implied volatilities of the i^{th} and j^{th} index constituent, respectively, and wᵢ,wⱼ≡a weight assigned to the i^{th} and j^{th} constituent.

In a second aspect, a method for calculating an implied correlation index value is disclosed. The method may include calculating a value reflecting an implied correlation of an index and a constituent of the index on a processor, where the value for the implied correlation having a dynamic value which reflects a performance of the index and the index constituent over a predefined time period. At least one value reflecting the implied correlation of the index and the index constituent is displayed on a trading facility display device coupled to a trading platform.

In a third aspect, a system for creating and trading derivatives based on an implied correlation between an implied volatility of stock index and implied volatilities of a plurality of constituents of the stock index is disclosed. The system includes an implied correlation index module coupled with a communications network for receiving current implied volatility values of a stock index and a plurality of constituents of the stock index and calculating an implied volatility value and generating an implied correlation index value. A dissemination module is coupled with the implied correlation index module and the communications network for receiving the implied correlation index value from the implied correlation index module and disseminating the implied correlation index value to at least one market participant. A trading module coupled with the dissemination module and the communications network is configured to receive at least one buy or sell order for a derivative investment instrument based on the implied correlation index value, and to execute the at least one buy or sell order.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a graph illustrating one embodiment of an example implied correlation index showing the high, low and close for the index for 71 days in the sample time series.

FIG. 2 is a block diagram of a system for creating and trading derivative investment instruments based on an implied correlation index.

FIG. 3 is a block diagram of a general computing device and network connectivity.

### DETAILED DESCRIPTION

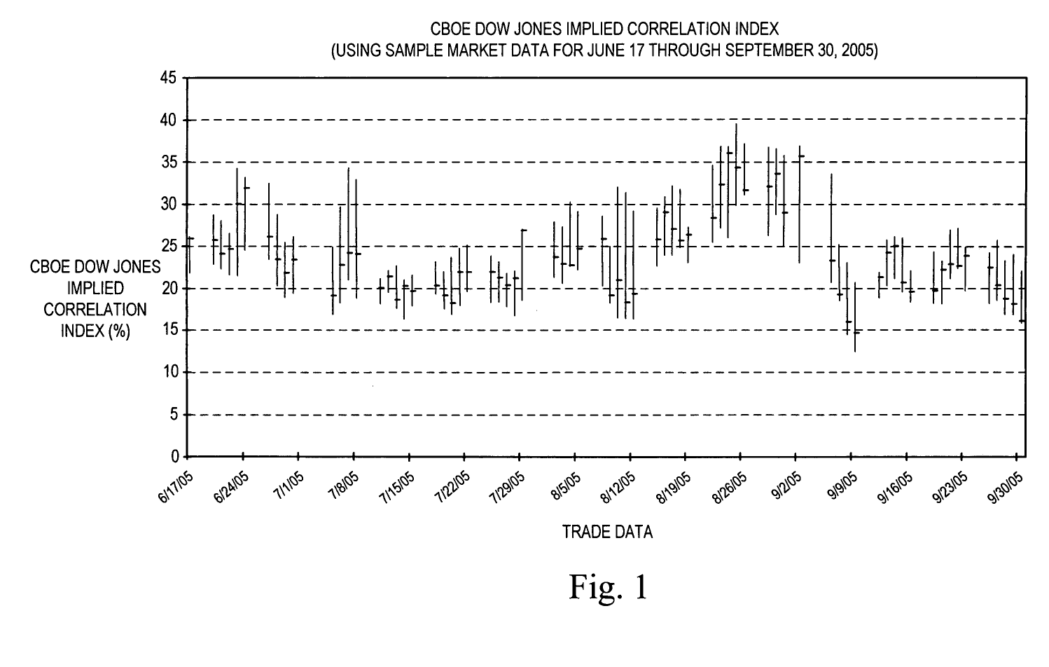

Referring now to FIG. 1, a chart showing values for an implied correlation index is illustrated that is designed to reflect an indication of the correlation between the implied volatility of index options, such as the Dow Jones® index options (“DJX”), and the implied volatilities of options on the constituent stocks that constitute the index on which the index options are based. The implied correlation index may be disseminated by an exchange intraday, and a new index value could be calculated frequently, for example, four times per minute. An implied correlation index, as well as derivative investment instruments based on such an index disseminated by an exchange, such as the Chicago Board Options Exchange®, 400 South LaSalle Street, Chicago, Ill. 60605 (“CBOE”), may be useful in several ways. In particular, the implied correlation index calculations are useful in evaluating the potential for an option trading strategy known as volatility dispersion (correlation) trading. Therefore, an exchange, such as the CBOE, could use the implied correlation index to promote a trading strategy that involves exchange-specific proprietary derivative investment instrument products (for example, DJX options). Additionally, a benchmark to measure the performance of volatility dispersion trading strategy may be created.

Typically, a volatility dispersion trade is characterized by selling at-the-money straddles in index options and purchasing at-the-money straddles in options on the constituent stocks of the index that serves as the basis for the index options. One interpretation of this strategy is that when implied correlation is high, index option premiums are “rich” relative to the premiums on individual equity options. Therefore, it may be profitable to sell the rich index option premium and buy the relatively inexpensive equity premiums.

The construction of the implied correlation index utilizes the implied volatilities of standardized derivative investment instruments, such as, by way of example below, the Dow Jones Index (DJX) options and the implied volatilities of options on the 30 constituent stocks of the index.

Example Implied Correlation Index Construction

The underpinning for calculation of the implied correlation index is a formula for calculating the risk, expressed in terms of standard deviation of returns, of a portfolio of stocks. The formula, shown below, relates the risk of the portfolio with the standard deviations, portfolio weights, and pair-wise correlations of the components of the portfolio. This formula is expressed as:

$${σ}_{p}^{2} = {\sum }_{i = 1}^{N} {w}_{i}^{2} {σ}_{i}^{2} + 2 {\sum }_{i = 1}^{N} {\sum }_{j > i} {w}_{i} {w}_{j} {σ}_{i} {σ}_{j} {corr}_{ij}$$

Rather than using pair-wise correlations, the present disclosure assumes that the correlations are all substantially the same and constant. For example, the correlation between Stock 1 and Stock 2 is the same as the correlation between Stock 1 and Stock 3. Solving the above equation for the assumed constant correlation gives the formula for the implied correlation index shown below:

$$corr = ( {σ}_{p}^{2} - {\sum }_{i = 1}^{N} {w}_{i}^{2} {σ}_{i}^{2} ) / 2 {\sum }_{i = 1}^{N} {\sum }_{j > i} {w}_{i} {w}_{j} {σ}_{i} {σ}_{j}$$

where, σₚ≡an implied volatility of the stock index (for example, DJX option implied volatility), σᵢ,σⱼ≡an implied volatilities of the i^{th} and j^{th} index constituent, respectively (equity option implied volatilities),and wᵢ,wⱼ≡the weight assigned to the i^{th} and j^{th} constituent in the index calculation.

In order to calculate the implied correlation index, at-the-money implied volatilities are preferably used for the index and its constituent stocks. The series with a strike price closest to the current stock price are selected as the at-the-money series. The implied volatilities for both puts and calls with the at-the-money strike price are then averaged to determine the at-the-money implied volatility. The weight of each constituent in the index is determined by dividing its stock price by the contemporaneous level of the index. Alternative weightings can be based on the index that is employed. Also, the index constituents may be any of a number of investment vehicles or criteria, including equity securities, fixed income securities, foreign currency exchange rates, interest rates, and commodity or structured products traded on a trading facility or over-the-counter market.

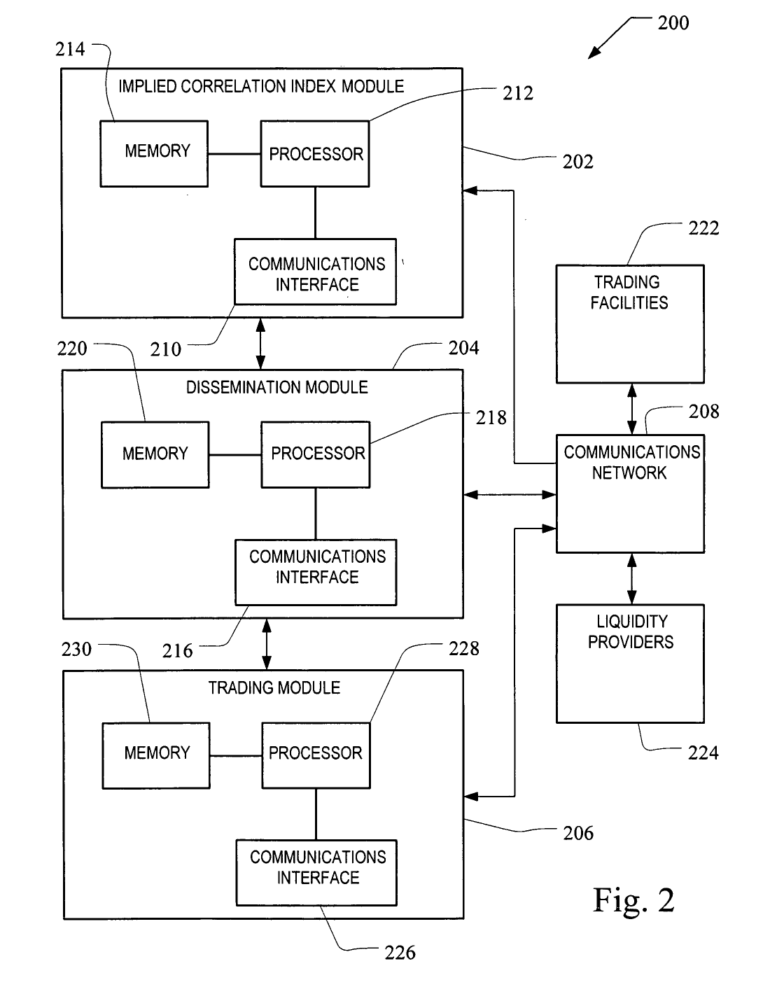

FIG. 2 is a block diagram of a system 200 for creating and trading derivative investment instruments based on an implied correlation index. Generally, the system comprises an implied correlation index module 202, a dissemination module 204 coupled with the implied correlation index module 202, and a trading module 206 coupled with the dissemination module 204. Typically, each module 202, 204, 206 is also coupled to a communication network 208 coupled to various trading facilities 222 and liquidity providers 224.

The implied correlation index module 202 comprises a communications interface 210, a processor 212 coupled with the communications interface 210, and a memory 214 coupled with the processor 212. Logic stored in the memory 214 is executed by the processor 212 such that the implied correlation index module 202 may receive a first set of trade information, including implied volatility values for a stock index and constituents stocks of the index, through the communications interface 210; aggregate that first set of trade information over a first time period, calculate an index of implied correlation for the desired group of underlying assets with the aggregated first set of trade information, and a standardized measure of the index; and pass the calculated values to the dissemination module 204.

The dissemination module 204 comprises a communications interface 216, a processor 218 coupled with the communications interface 216, and a memory 220 coupled with the processor 218. Logic stored in the memory 220 is executed by the processor 218 such that the dissemination module 204 may receive the calculated values from the implied correlation index module 202 through the communications interface 216, and disseminate the calculated values over the communications network 208 to various market participants 222.

The trading module 206 comprises a communications interface 226, a processor 228 coupled with the communications interface 226, and a memory 230 coupled with the processor 228. Logic stored in the memory 230 is executed by the processor 228 such that the trading module 206 may receive buy or sell orders over the communications network 208, as described above, and pass the results of the buy or sell order to the dissemination module 204 to be disseminated over the communications network 208 to the market participants 222.

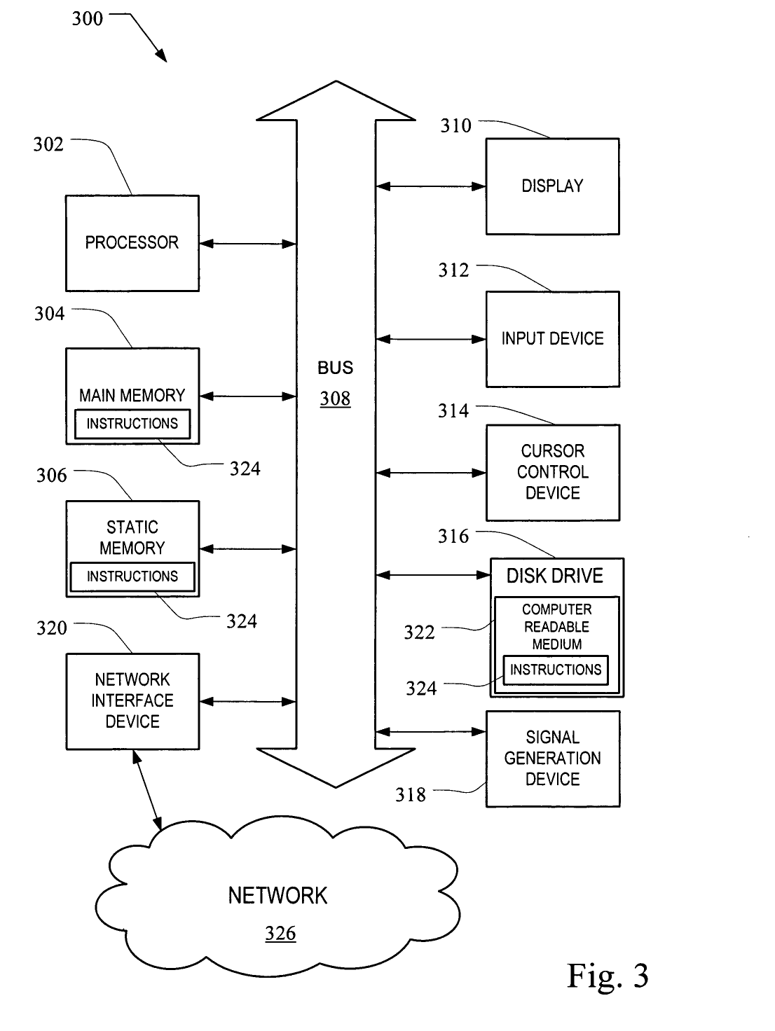

Referring to FIG. 3, an illustrative embodiment of a general computer system that may be used for one or more of the components shown in FIG. 2, or in any other trading system configured to carry out the methods discussed above, is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306 that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used on financial exchanges, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As will be appreciated by those of ordinary skill in the art, mechanisms for creating an implied correlation index, derivative investment instruments based thereon and other features described above may all be modified for application to other derivative investment instruments, such as futures, within the purview and scope of the present invention. An advantage of the disclosed methods and derivative investment instruments is that more traders at the exchange may have more opportunity to trade new products and obtain new and valuable market information, thus increasing visibility of orders and the desirability of maintaining a presence at the exchange.

The matter set forth in the foregoing description, accompanying drawings and claims is offered by way of illustration only and not as a limitation. While particular embodiments have been shown and described, it will be apparent to those skilled in the art that changes and modifications may be made without departing from the broader aspects of applicants' contribution. It is therefore intended that the foregoing detailed description be regarded as illustrative rather than limiting, and that it be understood that it is the following claims, including all equivalents, that are intended to define the scope of this invention.

What is claimed is:

1. A computer-readable medium containing processor executable program instructions for creating an implied correlation index comprising:
obtaining implied volatility values for a stock index and a plurality of constituents of the stock index;
calculating a value reflecting an implied correlation between the stock index and the plurality of constituents of the stock index; and
wherein a value reflecting an implied correlation is calculated according to the formula:
$$corr = ( {σ}_{p}^{2} - {\sum }_{i = 1}^{N} {w}_{i}^{2} {σ}_{i}^{2} ) / 2 {\sum }_{i = 1}^{N} {\sum }_{j > i} {w}_{i} {w}_{j} {σ}_{i} {σ}_{j}$$
where, σₚ≡an implied volatility of the stock index, σᵢ,σⱼ≡implied volatilities of the i^{th} and j^{th} index constituent, respectively, and wᵢ,wⱼ≡a weight assigned to the i^{th} and j^{th} constituent.

2. The computer-readable medium of claim 1, wherein the implied volatility values are at-the-money implied volatility values.

3. The computer-readable medium of claim 2, wherein the at-the-money implied volatility values are derived from a series with a strike price closest to a current stock price.

4. The computer-readable medium of claim 3, wherein the at-the-money implied volatility values are calculated by averaging puts and calls and at-the-money strike price.

5. The computer-readable medium of claim 1, wherein the weight assigned to each of the plurality of constituents of the stock index is determined by dividing a stock price of each of the plurality of constituents by a contemporaneous level of the index.

6. A method for calculating an implied correlation index value, the method comprising:
calculating a value reflecting an implied correlation of an index and an index constituent on a processor, the value for the implied correlation having a dynamic value which reflects a performance of the index and the index constituent over a predefined time period; and
displaying at least one value reflecting the implied correlation of the index and the index constituent on a trading facility display device coupled to a trading platform.

7. The method according to claim 6, wherein calculating the value reflecting the implied correlation of the index and the index constituent comprises:
calculating an implied correlation value reflecting implied volatility values according to the formula:
$$corr = ( {σ}_{p}^{2} - {\sum }_{i = 1}^{N} {w}_{i}^{2} {σ}_{i}^{2} ) / 2 {\sum }_{i = 1}^{N} {\sum }_{j > i} {w}_{i} {w}_{j} {σ}_{i} {σ}_{j}$$
where, σₚ≡an implied volatility of a stock index, σᵢ,σⱼ≡implied volatilities of the i^{th} and j^{th} index constituent, respectively, and wᵢ,wⱼ≡a weight assigned to the i^{th} and j^{th} constituent.

8. The method according to claim 6, further comprising the step of transmitting at least one implied correlation derivative quote of a liquidity provider from the trading facility to at least one market participant.

9. The method according to claim 7, wherein the implied volatility values are at-the-money implied volatility values.

10. The method according to claim 9, wherein the at-the-money implied volatility values are derived from a series with a strike price closest to a current stock price.

11. The method according to claim 10, wherein the at-the-money implied volatility values are calculated by averaging puts and calls at an at-the-money strike price.

12. The method according to claim 11, wherein the weight assigned to the each index constituent is determined by dividing a stock price for each index constituent by a contemporaneous level of the stock index.

13. The method according to claim 6, wherein the index constituent is selected from the group consisting of: equity securities, fixed income securities, foreign currency exchange rates, interest rates, and commodity or structured products traded on a trading facility or over-the-counter market.

14. A system for creating and trading derivatives based on an implied correlation between an implied volatility of stock index and implied volatilities of a plurality of constituents of the stock index, comprising:
an implied correlation index module comprising a first processor, a first memory coupled with the first processor, and a first communications interface coupled with a communications network, the first processor, and the first memory;
a dissemination module coupled with the implied correlation index module, the dissemination module comprising a second processor, a second memory coupled with the second processor, and a second communications interface coupled with the communications network, the second processor, and the second memory;
a first set of logic, stored in the first memory and executable by the first processor to receive current implied volatility values for the stock index and the plurality of constituents of the stock index of a implied correlation derivative through the first communications interface; calculate an implied correlation value; and pass the implied correlation value to the dissemination module; and
a second set of logic, stored in the second memory and executable by the second processor to receive the implied correlation value from the implied correlation index module; and disseminate the calculated implied correlation value through the second communications interface to at least one market participant.

15. The system of claim 14, further comprising:
a trading module coupled with the dissemination module, the trading module comprising a third processor, a third memory coupled with the third processor, and a third communications interface coupled with the communications network, the third processor, and the third memory;
a third set of logic, stored in the third memory and executable by the third processor, to receive at least one buy or sell order over the communications network; execute the buy or sell order; and pass a result of the buy or sell order to the dissemination module; and
a fourth set of logic, stored in the second memory and executable by the second processor to receive the result of the buy or sell order from the trading module and disseminate the result of the buy or sell order through the second communications network to the at least one market participant.

16. A system for creating and trading derivatives based on an implied correlation between an implied volatility of stock index and implied volatilities of a plurality of constituents of the stock index, comprising:
an implied correlation index module coupled with a communications network for receiving current implied volatility values of a stock index and a plurality of constituents of the stock index and calculating an implied volatility value and generating an implied correlation index value;
a dissemination module coupled with the implied correlation index module and the communications network for receiving the implied correlation index value of from the implied correlation index module, and disseminating the implied correlation index value to at least one market participant; and
a trading module coupled with the dissemination module and the communications network for receiving at least one buy or sell order for a derivative investment instrument based on the implied correlation index value, and executing the at least one buy or sell order.
